(19) United States
(12) Patent Application Publication
(10) Pub. No.: US 2022/0065201 A1
(43) Pub. Date: Mar. 3, 2022

(54) LEAKAGE DIAGNOSTIC DEVICE FOR EVAPORATED FUEL TREATMENT APPARATUS

(71) Applicant: AISAN KOGYO KABUSHIKI KAISHA, Obu-shi, Aichi (JP)

(72) Inventors: Yoshihiko HONDA, Obu-shi (JP); Takanori AKIYAMA, Nagoya-shi (JP); Rina KONDO, Nagoya-shi (JP)

(73) Assignee: AISAN KOGYO KABUSHIKI KAISHA, Obu-shi, Aichi (JP)

(21) Appl. No.: 17/311,944

(22) PCT Filed: Nov. 27, 2019
(86) PCT No.: PCT/JP2019/046355

§ 371 Date: Jun. 8, 2021

(30) Foreign Application Priority Data
Dec. 27, 2018 (JP) 2018-244391

(51) Int. Cl. F02M 25/08

(52) U.S. Cl. CPC F02M 25/0818; F02M 25/0872; F02M 25/0854

(57) ABSTRACT

An evaporated fuel treatment apparatus includes: a canister; a purge passage; a purge pump provided in the purge passage; and an atmosphere passage communicating with the canister. A leakage diagnostic device includes: two bypass passages provided between the purge passage on the upstream side of the purge pump and the atmosphere passage; a reference orifice; two three-way valves; a pressure sensor; and an ECU. When operating the purge pump under a predetermined condition, the ECU controls the two three-way valves to set a mode in which atmospheric air is pressure-fed into an air intake passage through the reference orifice and the purge pump, and a mode in which vapors in the canister are pressure-fed into the air intake passage through the reference orifice and the purge pump, and determines leakage by comparing a reference pressure and a leakage pressure that are measured when these modes are set.

### TECHNICAL FIELD

The technique disclosed in this description relates to a leakage diagnostic device for an evaporated fuel treatment apparatus to diagnose leakage in the evaporated fuel treatment apparatus for purging and treating evaporated fuel generated in a fuel tank to an intake passage.

### BACKGROUND ART

As a technique of the above type, conventionally, there is known for example an evaporated fuel treatment apparatus disclosed in the following Patent Document 1. This apparatus is provided with a dedicated electrically-operated pump to be used for leakage detection and is configured to detect leakage of evaporated fuel in a ventilation device including a canister for adsorbing fuel vapor (evaporated fuel) generated in a fuel tank. This apparatus is configured to create a pressure difference between the inside and the outside of the ventilation device according to a pressurizing force or a pressure-reducing force applied by the operation of the electrically-operated pump to inspect a leakage state of the ventilation device. Herein, this apparatus is provided with a reference orifice used for comparison of the above-mentioned pressure difference, a unit for applying a pressurizing force or a pressure-reducing force to the reference orifice to create a reference pressure difference and detecting this reference pressure difference, and a unit for correcting the rotation speed, i.e., the rotation number, of an electrically-operated motor, i.e., a motor section, to adjust the detected reference pressure difference to a predetermined pressure difference.

### RELATED ART DOCUMENTS

### Patent Documents

Patent Document 1: Japanese unexamined patent application publication No. 2006-37752

### SUMMARY OF INVENTION

### Problems to be Solved by the Invention

However, in the apparatus disclosed in the Patent Document 1, the dedicated electrically-operated pump is required to detect leakage. Therefore, if an electrically-operated pump (namely, a purge pump) is provided to be used for a purpose other than leakage detection, e.g., used for purging evaporated fuel to an intake passage, an electrically-operated pump dedicated for leakage detection has to be additionally provided. This may increase the number of components of the entire apparatus and result in a complicated configuration, and increase a manufacturing cost of the apparatus.

The present disclosure has been made to address the above problems and has a purpose to provide a leakage diagnostic device for an evaporated fuel treatment apparatus, capable of effectively diagnosing leakage while dispensing with a dedicated pump for leakage diagnosis, thereby preventing an increase in the number of components of the leakage diagnostic device and a complicated configuration.

### Means of Solving the Problems

(1) To achieve the aforesaid purpose, one aspect of the present invention provides a leakage diagnostic device for diagnosing leakage in an evaporated fuel treatment apparatus for purging and treating evaporated fuel generated in a fuel tank to an intake passage of an engine, wherein the evaporated fuel treatment apparatus comprises: a canister configured to trap the evaporated fuel generated in the fuel tank, the canister including an inlet port for introducing the evaporated fuel from the fuel tank into the canister, an outlet port for discharging the evaporated fuel from the canister, and an atmosphere port for introducing atmospheric air into the canister; a purge passage configured to guide the evaporated fuel trapped in the canister to the intake passage through the outlet port; a purge pump provided in the purge passage and configured to pressure-feed the evaporated fuel trapped in the canister to the intake passage through the purge passage; and an atmosphere passage configured to introduce atmospheric air into the canister through the atmosphere port, the leakage diagnostic device comprises: a first bypass passage connecting between the purge passage upstream of the purge pump and the atmosphere passage; a second bypass passage arranged in parallel with the first bypass passage between the purge passage upstream of the purge pump and the atmosphere passage, the second bypass passage having one end connected to the purge passage downstream of a first junction in which the first bypass passage and the purge passage are connected to each other and an other end connected to the atmosphere passage upstream of a junction in which the atmosphere passage and the first bypass passage are connected to each other; a reference orifice provided in the first bypass passage and configured to create a pressure difference between the purge passage and the atmosphere passage; a first communication switching unit configured to selectively switch between communication of the purge passage in the first junction and communication between the purge passage downstream of the first junction and the first bypass passage; a second communication switching unit configured to selectively switch between communication between the atmosphere passage and the second bypass passage in a second junction in which the atmosphere passage and the second bypass passage are connected to each other and communication of the atmosphere passage in the second junction; a pressure detecting unit configured to detect a passage pressure in the purge passage between the purge pump and the first junction; and a control unit configured to control the purge pump, the first communication switching unit, and the second communication switching unit, and diagnose the leakage based on the passage pressure detected, and the control unit is configured to: control the first communication switching unit and the second communication switching unit under a predetermined condition during operation of the purge pump to sequentially set a reference pressure measurement mode in which atmospheric air is pressure-fed into the intake passage through the reference orifice and the purge pump and a leakage measurement mode in which the evaporated fuel trapped in the canister is pressure-fed into the intake passage through the reference orifice and the purge pump; measure a reference pressure based on the passage pressure detected when the reference pressure measurement mode is set; measure a leakage pressure based on the passage pressure detected when the leakage measurement mode is set, and compare between the measured reference pressure and the measured leakage pressure to determine whether or not the leakage exists.

According the above-described configuration (1), the purge pump that is originally used to pressure-feed evaporated fuel to an intake passage is utilized. For the purge passage located upstream of this purge pump and the atmosphere passage, there are provided the first bypass passage, the second bypass passage, the reference orifice, the first communication switching unit, the second communication switching unit, and the pressure detecting unit. Thus, a leakage in the evaporated fuel treatment apparatus is diagnosed by simple comparison between the reference pressure measured when the reference pressure measurement mode is set and the leakage pressure measured in the leakage measurement mode. Accordingly, this configuration needs no additional pump dedicated for leakage diagnosis. Furthermore, the purge pump is provided in the purge passage. When a flow of evaporated fuel from the canister to the purge pump is shut off by the first communication switching unit, the second bypass passage is connected to a suction side of the purge pump through the second communication switching unit provided on the side of the atmosphere passage in which evaporated fuel is less likely flow, so that the inside of the canister is set in a negative pressure.

(2) To achieve the foregoing purpose, in the above-described configuration (1), the reference orifice has an opening area set to a predetermined reference value.

According the above-described configuration (2), in addition to the operations of the configuration (1), for example, even when a vehicle is stopped in a high-altitude place and the leakage diagnosis is performed, a flow of air is caused to pass through an orifice corresponding to the opening area of the reference orifice and the leakage pressure under the atmospheric pressure in such a high-altitude place is compared with the reference pressure in the high-altitude place, so that leakage can be effectively determined.

(3) To achieve the foregoing purpose, the above-described configuration (1) or (2) further includes a unit configured to detect or estimate a fuel temperature in the fuel tank, wherein the predetermined condition includes a condition that the detected or estimated fuel temperature is equal to or lower than a predetermined value.

According the above-described configuration (3), in addition to the operations of the configuration (1) or (2), the leakage diagnosis is performed in a state where the fuel temperature is equal to or lower than the predetermined value, that is, in a state where less evaporated fuel is released into the atmosphere passage.

(4) To achieve the foregoing purpose, in any one of the above-described configurations (1) to (3) further includes a unit configured to detect or estimate a concentration of the evaporated fuel trapped in the canister, wherein the predetermined condition includes a condition that the detected or estimated concentration of the evaporated fuel is equal to or lower than a predetermined value.

According the above-described configuration (4), in addition to the operations of any one of the configurations (1) to (3), the leakage diagnosis is performed in a state where the fuel concentration is equal to or lower than the predetermined value, that is, in a state where less evaporated fuel is released into the atmosphere passage.

### Effects of the Invention

According to the foregoing configuration (1), it is possible to dispense with a dedicated pump for leakage diagnosis and perform effective leakage diagnosis while preventing an increase in the number of components of the leakage diagnostic device and a complicated configuration.

According to the foregoing configuration (2), in addition to the effects of the configuration (1), it is possible to enhance the accuracy of leakage diagnosis.

According to the foregoing configuration (3), in addition to the effects of the configuration (1) or (2), it is possible to prevent release of evaporated fuel into the atmosphere during leakage diagnosis.

According to the foregoing configuration (4), in addition to the effects of any one of the configurations (1) to (3), it is possible to prevent release of evaporated fuel into the atmosphere during leakage diagnosis.

### BRIEF DESCRIPTION OF THE DRAWINGS

FIG. 1 is a schematic diagram of an engine system including an evaporated fuel treatment apparatus and a leakage diagnostic device for the evaporated fuel treatment apparatus which are mounted in a vehicle in an embodiment;

FIG. 2 is a flowchart showing contents of leakage diagnosis control in the embodiment;

FIG. 3 is a schematic diagram showing the flow of air in the evaporated fuel treatment apparatus in a reference pressure measurement mode in the embodiment;

FIG. 4 is a schematic diagram showing the flow of vapor and others in the evaporated fuel treatment apparatus in a leakage measurement mode in the embodiment; and

FIG. 5 is a schematic diagram showing the flow of vapor and others in the evaporated fuel treatment apparatus in a purge control mode in the embodiment.

### MODE FOR CARRYING OUT THE INVENTION

A detailed description of an embodiment of a leakage diagnostic device for an evaporated fuel treatment apparatus will now be given referring to the accompanying drawings.

(Outline of Engine System)

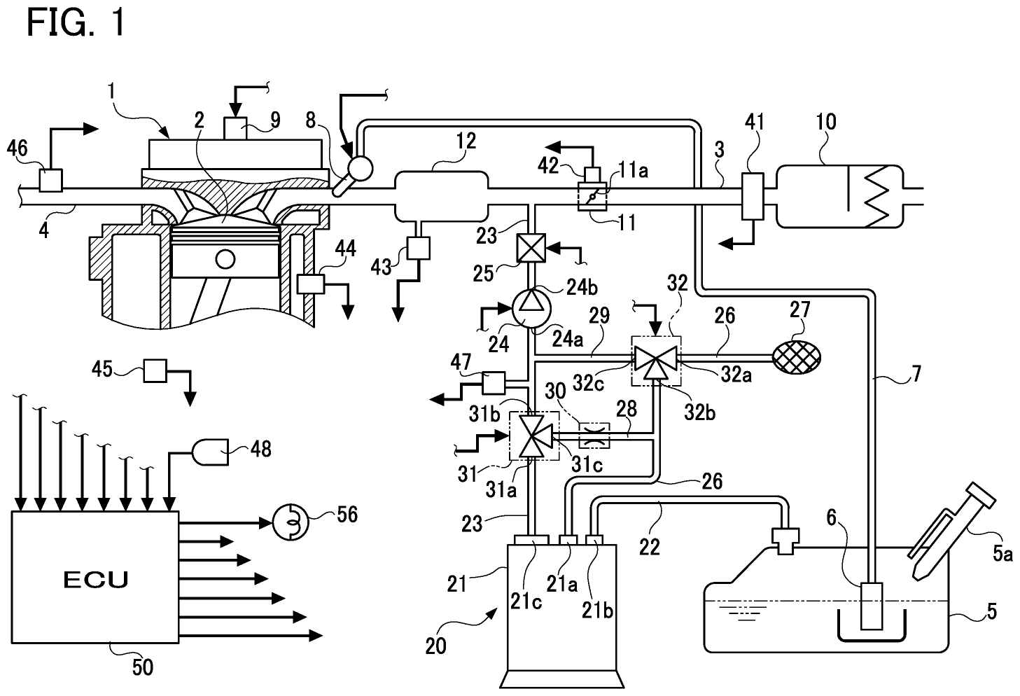

FIG. 1 is a schematic diagram showing an engine system including an evaporated fuel treatment apparatus 20 and a leakage diagnostic device for this evaporated fuel treatment apparatus 20 which are mounted in a vehicle. The engine 1 is provided with an intake passage 3 for sucking air and others into a combustion chamber 2 and an exhaust passage 4 for exhausting exhaust gas from the combustion chamber 2. The combustion chamber 2 is supplied with fuel stored in a fuel tank 5. Specifically, the fuel in the fuel tank 5 is ejected by a fuel pump 6 built in the fuel tank 5 into a fuel passage 7 and pressure-fed to an injector 8 provided in an intake port of the engine 1. The pressure-fed fuel is injected from the injector 8 together with air (intake air) flowing through the intake passage 3 into the combustion chamber 2, forming a combustible air-fuel mixture, which is burnt therein. The engine 1 is further provided with an ignition device 9.

In the intake passage 3, there are provided an air cleaner 10, a throttle device 11, and a surge tank 12 in order from an inlet side of the intake passage 3 toward the engine 1. The throttle device 11 includes a throttle valve 11a to be opened and closed to adjust a flow rate of intake air flowing through the intake passage 3. The opening and closing of the throttle valve 11a is performed in synchronization with the operation of an accelerator pedal (not shown) by a driver. The surge tank 12 smoothens pulsation of intake air in the intake passage 3.

(Configuration of Evaporated Fuel Treatment Apparatus)

In FIG. 1, the evaporated fuel treatment apparatus 20 in the present embodiment is configured to treat evaporated fuel (vapor) generated in the fuel tank 5 without releasing the evaporated fuel to the atmosphere. This apparatus 20 includes a canister 21 to trap the vapor generated in the fuel tank 5, a vapor passage 22 to guide the vapor from the fuel tank 5 to the canister 21, a purge passage 23 to guide and purge the vapor trapped in the canister 21 to the intake passage 3, an electrically-operated purge pump 24 provided in the purge passage 23 to pressure-feed the vapor trapped in the canister 21 to the intake passage 3 through the purge passage 23, an electrically-operated purge valve 25 provided in the purge passage 23 to open and close the purge passage 23, and an atmosphere passage 26 to introduce atmospheric air into the canister 21.

The canister 21 contains therein adsorption material such as activated carbon to adsorb vapor. The canister 21 includes an atmosphere port 21a for introducing atmospheric air thereto, an inlet port 21b for introducing the vapor thereto, and an outlet port 21c for discharging the vapor therefrom. The inlet port 21b of the canister 21 is connected to one end of the vapor passage 22. The other end of the vapor passage 22 communicates with the inside of the fuel tank 5. The outlet port 21c of the canister 21 is connected to one end of the purge passage 23. The other end of the purge passage 23 is connected to the intake passage 3 located between the throttle device 11 and the surge tank 12. The atmosphere port 21a of the canister 21 is connected to one end of the atmosphere passage 26. The other end of the atmosphere passage 26 is provided with an air filter 27 for trapping powder dust and others in air. The inside of the canister 21 can communicate with the atmosphere through the atmosphere passage 26.

In the present embodiment, the purge pump 24 includes a suction port 24a and an ejection port 24b and is configured to suck the vapor trapped in the canister 21 through the suction port 24a and eject the sucked vapor through the ejection port 24b. Further, the purge pump 24 is constituted of a centrifugal pump and configured to allow vapor or air to flow in one direction from the suction port 24a to the ejection port 24b.

(Configuration of Leakage Diagnostic Device)

The engine system in the present embodiment is provided with the leakage diagnostic device for diagnosing leakage in the above-described evaporated fuel treatment apparatus 20. As shown in FIG. 1, the leakage diagnostic device includes a first bypass passage 28 and a second bypass passage 29 arranged in parallel with each other between the purge passage 23 and the atmosphere passage 26, a reference orifice 30 provided in the first bypass passage 28, a first three-way valve 31 provided in a first junction in which the purge passage 23 and the first bypass passage 28 are connected to each other, a second three-way valve 32 provided in a second junction in which the second bypass passage 29 and the atmosphere passage 26 are connected to each other, a pressure sensor 47 provided in the purge passage 23 to detect a passage pressure PP of the purge passage 23, and an electronic control unit (ECU) 50.

The first bypass passage 28 is placed between the purge passage 23 upstream of the purge pump 24 and the atmosphere passage 26. The second bypass passage 29 is placed between the purge passage 23 upstream of the purge pump 24 and the atmosphere passage 26. The second bypass passage 29 has one end connected to the purge passage 23 located between the first three-way valve 31 and the purge pump 24 and the other end connected to the atmosphere passage 26 in the second junction upstream of a junction in which the atmosphere passage 26 and the first bypass passage 28 are connected to each other. The reference orifice 30 provided in the first bypass passage 28 serves to create a reference pressure difference between the purge passage 23 and the atmosphere passage 26. The opening area of this reference orifice 30 is set to a predetermined reference value. In the present embodiment, this reference value is set to for example the area corresponding to 0.5-equivalent in diameter.

The first three-way valve 31 is a valve device to selectively switch between communication, or opening, of the purge passage 23 in the first junction and communication between the purge passage 23 downstream of the first junction and the first bypass passage 28, and corresponds to one example of a first communication switching unit in the present disclosure. The second three-way valve 32 is a valve device to selectively switch between communication between the atmosphere passage 26 and the bypass passage 29 in the second junction in which the atmosphere passage 26 and the second bypass passage 29 are connected to each other and communication of the atmosphere passage 26 in the second junction, and corresponds to one example of a second communication switching unit in the present disclosure. The pressure sensor 47 is configured to detect the passage pressure PP in the purge passage 23 located between the purge pump 24 and the first three-way valve 31 and output an electric signal indicating a detection value thereof. In the present embodiment, a part of the purge passage 23, a part of the atmosphere passage 26, the first bypass passage 28, the second bypass passage 29, the reference orifice 30, the first three-way valve 31, and the second three-way valve 32 are integrally provided in a single housing.

The ECU 50 is configured to control the purge pump 24, the purge valve 25, the first three-way valve 31, and the second three-way valve 32 and further perform “leakage diagnosis control” to diagnose leakage based on the detected passage pressure PP. Furthermore, the ECU 50 is configured to control the purge pump 24, the purge valve 25, the first three-way valve 31, and the second three-way valve 32 under a predetermined condition to perform purge control to purge vapor to the intake passage 3.

In the present embodiment, each of the three-way valves 31 and 32 is electrically-operated and configured to switch each flow passage as described later. The first three-way valve 31 includes a first inlet 31a and an outlet 31b, which are connected to the purge passage 23, and a second inlet 31c connected to the first bypass passage 28. The first three-way valve 31 is configured to change over a flow passage to switch between a first communication state in which the first inlet 31a and the outlet 31b communicate with each other and a second communication state in which the second inlet 31c and the outlet 31b communicate with each other. In the present embodiment, the first three-way valve 31 is turned OFF to switch to the first communication state and the first three-way valve 31 is turned ON to switch to the second communication state. The second three-way valve 32 includes an inlet 32a and a first outlet 32b, which are connected to the atmosphere passage 26, and a second outlet 32c connected to the second bypass passage 29. The second three-way valve 32 is configured to change over a flow passage to switch between a first communication state in which the inlet 32a and the first outlet 32b communicate with each other and a second communication state in which the first outlet 32b and the second outlet 32c communicate with each other. In the present embodiment, the second three-way valve 32 is turned OFF to switch to the first communication state and the second three-way valve 32 is turned ON to switch to the second communication state.

In the foregoing configuration, in the purge passage 23 connected to the suction port 24a of the purge pump 24, the vapor is sucked into the purge pump 24 by a negative pressure. In the purge passage 23 connected to the ejection port 24b of the purge pump 24, the vapor is pushed out of the purge pump 24 by a positive pressure. The term “pressure-feed or fed” by the purge pump 24 includes both of those actions.

(Electrical Configuration of Engine System)

In the present embodiment, in addition to the foregoing pressure sensor 47, there are provided various sensors and others 41 to 46 to detect an operating state of the engine 1. The air flow meter 41 provided near the air cleaner 10 detects the amount of air to be sucked into the intake passage 3 as an intake amount and outputs an electrical signal indicating a detection value thereof. The throttle sensor 42 provided in the throttle device 11 detects an opening degree of the throttle valve 11a as a throttle opening degree and outputs an electrical signal indicating a detection value thereof. The intake pressure sensor 43 provided in the surge tank 12 detects the internal pressure of the surge tank 12 as an intake pressure PM and outputs an electrical signal indicating a detection value thereof. The water temperature sensor 44 provided in the engine 1 detects the temperature of cooling water flowing through the inside of the engine 1 as a cooling water temperature THW and outputs an electrical signal indicating a detection value thereof. The rotation speed sensor 45 provided in the engine 1 detects the rotational angle speed of a crank shaft (not shown) of the engine 1 as an engine rotation speed and outputs an electrical signal indicating a detection value thereof. The air/fuel ratio sensor (A/F sensor) 46 provided in the exhaust passage 4 detects a hydrocarbon concentration HC in exhaust gas and outputs an electrical signal indicating a detection value thereof.

At a driver's seat in a vehicle, an ignition switch (IGSW) 48 and a warning lamp 56 are provided. The IGSW 48 is operated by a driver to start up the engine 1. The warning lamp 56 is configured to light up when there is a leakage (leakage in a pipe or malfunction of each three-way valve 31, 32, etc.) in the evaporated fuel treatment apparatus 20.

In the present embodiment, the electronic control unit (ECU) 50 configured to perform various controls receives various signals outputted from various sensors and others 41 to 48. The ECU 50 is configured to control the injector 8, the ignition device 9, the purge pump 24, the purge valve 25, the first three-way valve 31 and the second three-way valve 32 to execute fuel injection control, ignition timing control, purge control, fuel temperature estimation processing, altitude estimation processing, vapor concentration estimation processing, and leakage diagnosis control, and others.

Herein, the fuel injection control is configured to control the injector 8 according to the operating state of the engine 1 to thereby control a fuel injection amount and a fuel injection timing. The ignition timing control is configured to control the ignition device 9 according to the operating state of the engine 1 to thereby control an ignition timing of a combustible air-fuel mixture.

In the present embodiment, the purge control is configured to control the purge pump 24, the purge valve 25, the first three-way valve 31, and the second three-way valve 32 in the evaporated fuel treatment apparatus 20 according to the operating state of the engine 1 to thereby purge the vapor trapped in the canister 21 to the intake passage 3 through the purge passage 23.

The fuel temperature estimation processing is configured to estimate a fuel temperature TF in the fuel tank 5 based on for example the cooling water temperature THW detected by the water temperature sensor 44. After a lapse of several hours from stop of the engine 1, the cooling water temperature THW is substantially equal to the outside air temperature and the fuel temperature TF. Thus, this estimation can be performed based on the cooling water temperature THW. In the present embodiment, the water temperature sensor 44 and the ECU 50 correspond to a unit for estimating the fuel temperature TF (a fuel temperature estimation unit).

The altitude estimation processing is configured to estimate the altitude AL at which a vehicle is stopped based on for example the passage pressure PP detected by the pressure sensor 47. In the present embodiment, the pressure sensor 47 and the ECU 50 correspond to a unit for estimating an altitude AL.

The vapor concentration estimation processing is configured to estimate a vapor concentration DV of the vapor adsorbed to the canister 21 based on for example a hydrocarbon concentration HC detected by the A/F sensor 46. In the present embodiment, the A/F sensor 46 and the ECU 50 correspond to a unit for estimating a vapor concentration (a concentration of evaporated fuel). Herein, the details of the above-described processings are well known and thus not elaborated upon here.

In the present embodiment, the ECU 50 corresponds to one example of a control unit in the present disclosure. The ECU 50 is provided with a well-known configuration including a central processing unit (CPU), a read only memory (ROM), a random-access memory (RAM), a backup RAM, and others. The ROM has stored in advance predetermined control programs related to the foregoing various controls. The ECU (CPU) 50 is configured to execute the foregoing various controls according to those control programs.

In the present embodiment, the fuel injection control, the ignition timing control, and the purge control each have well-known contents and only the leakage diagnosis control will be described below in detail.

(Leakage Diagnosis Control)

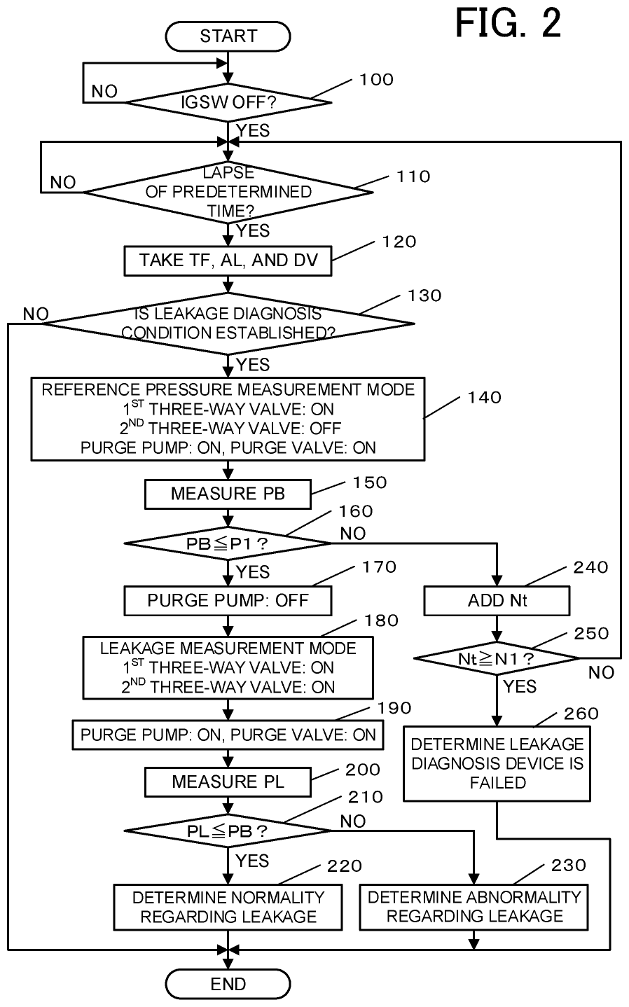

The leakage diagnosis control will be described blow. FIG. 2 is a flowchart showing the contents of this control. The ECU 50 periodically executes this routine at predetermined time intervals.

When the processing enters this routine, the ECU 50 waits, in step 100, until the IGSW 48 is turned off, that is, waits until the engine 1 is stopped, and then advances to step 110.

In step 110, the ECU 50 waits for a lapse of a predetermined time from when the engine 1 is stopped, and then advances to step 120.

In step 120, the ECU 50 takes an estimated fuel temperature TF, an altitude AL, and a vapor concentration DV.

In step 130, the ECU 50 subsequently determines whether or not the leakage diagnosis condition has been established. Herein, when the fuel temperature TF falls within a predetermined range and also the altitude AL is equal to or lower than a predetermined height and further the vapor concentration DV is equal to or lower than a predetermined value, it can be determined that the leakage diagnosis condition has been established. When the result of this determination is affirmative, the ECU 50 advances the processing to step 140. When the result of this determination is negative, the ECU 50 terminates subsequent processing once.

In step 140, the ECU 50 sets a “reference pressure measurement mode”. Specifically, the ECU 50 turns ON the first three-way valve 31, turns OFF the second three-way valve 32, turns ON the purge pump 24 and further controls the purge pump 24 with a constant rotation speed, and turns ON the purge valve 25 to control the purging of vapor at a constant flow rate. Herein, the purge pump 24 and the purge valve 25 are controlled so as not to generate excessive high negative pressure by the purge pump 24 to thereby adjust a reference pressure PB which will be mentioned later.

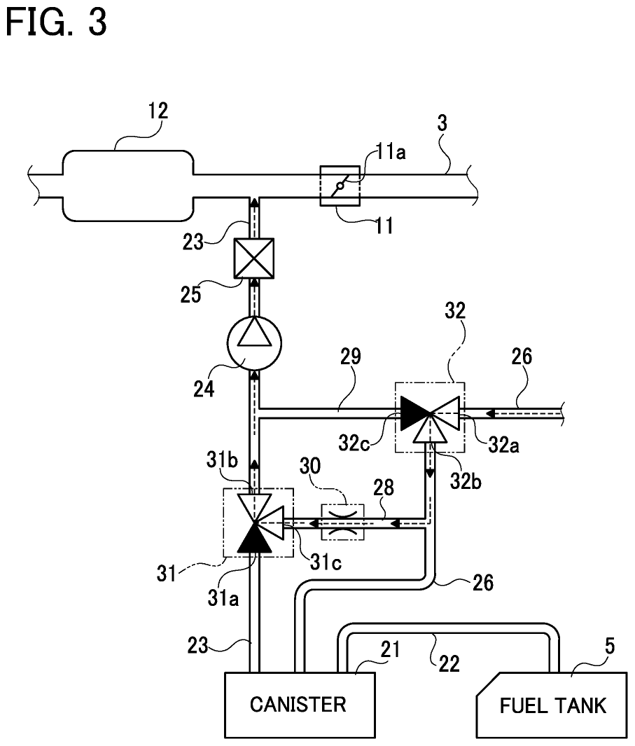

FIG. 3 shows, in a schematic diagram, the flow of air (indicated by dashed arrows) in the evaporated fuel treatment apparatus 20 in the reference pressure measurement mode. As shown in FIG. 3, the air sucked from the atmosphere into the atmosphere passage 26 passes through the second three-way valve 32, the atmosphere passage 26, the first bypass passage 28, the reference orifice 30, the first three-way valve 31, the purge passage 23, the purge pump 24, and the purge valve 25, and then flows in the intake passage 3 through an outlet of the purge passage 23.

In step 150, the ECU 50 measures the passage pressure PP detected by the pressure sensor 47 as the reference pressure PB.

In step 160, the ECU 50 determines whether or not the reference pressure PB is equal to or less than a predetermined value P1. When this determination result is affirmative, the ECU 50 advances the processing to step 170. When this determination result is negative, the ECU 50 shifts the processing to step 240.

In step 170, the ECU 50 turns OFF the purge pump 24.

In step 180, the ECU 50 sets a leakage measurement mode. Specifically, the ECU 50 turns ON the first three-way valve 31 and turns ON the second three-way valve 32.

In step 190, the ECU 50 turns ON the purge pump 24 and turns ON the purge valve 25.

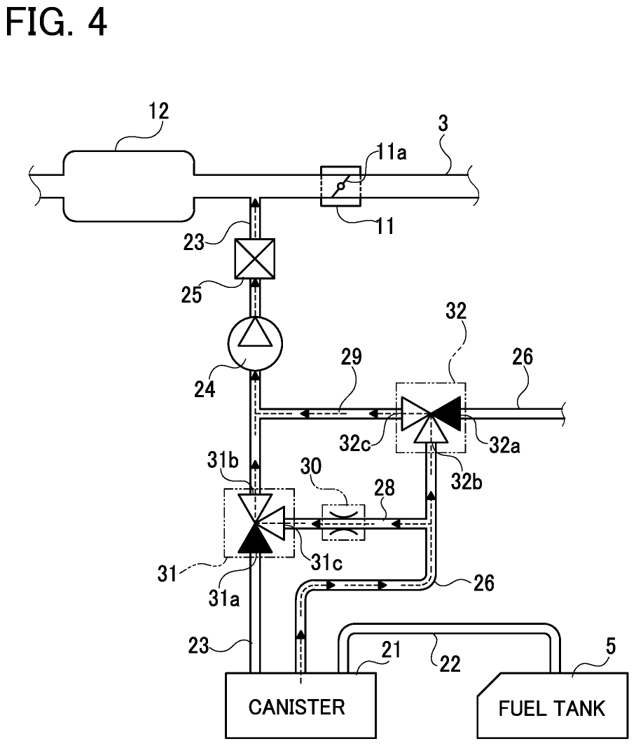

FIG. 4 is a schematic diagram showing the flow of vapor and others (indicated by dashed arrows) in the evaporated fuel treatment apparatus 20 in the leakage measurement mode. As shown in FIG. 4, the vapor flowing out of the canister 21 into the atmosphere passage 26 passes through the first bypass passage 28, the reference orifice 30, the first three-way valve 31, and the purge passage 23 and also merges with the vapor having passed through the first three-way valve 31 through the second three-way valve 32 and the second bypass passage 29, and further passes through the purge pump 24 and the purge valve 25 and then flows in the intake passage 3 through the outlet of the purge passage 23.

In step 200, the ECU 50 measures a leakage pressure PL based on a detection value of the pressure sensor 47.

In step 210, the ECU 50 determines whether or not the leakage pressure PL is a reference pressure PB or lower. When this determination result is affirmative, the ECU 50 advances the processing to step 220. When this determination result is negative, the ECU 50 shifts the processing to step 230.

In step 220, the ECU 50 determines that it is normal regarding leakage, i.e., with no leakage, and terminates subsequent processings once. At that time, for example, the ECU 50 may store this determination of normality in a memory.

In step 230, on the other hand, the ECU 50 determines that it is abnormal regarding leakage, i.e., with a leakage, and terminates subsequent processings once. At that time, for example, the ECU 50 may store this determination of abnormality in a memory or execute an abnormality notifying operation by for example blinking a warning lamp 56.

In step 240 following step 160, on the other hand, the ECU 50 adds the number of times Nt at which the determination result in step 160 is NO.

In step 250, the ECU 50 then determines whether or not the number of times Nt is a predetermined value N1 or larger. This predetermined value N1 can be set to “several times”. When this determination result is affirmative, the ECU 50 advances the processing to step 260. When this determination result is negative, the ECU 50 returns the processing to step 110.

In step 260, the ECU 50 determines the leakage diagnostic device as being failed, and terminates subsequent processing once. Herein, assumable failures of the leakage diagnostic device may include for example a malfunction of the purge pump 24, a closed failure in which the purge valve 25 is stuck in a closed state, and others. At this time, the ECU 50 can store this failure determination in a memory and execute a failure notifying operation by for example blinking the warning lamp 56.

According to the above-described leakage diagnosis control, the ECU 50 is configured to control the first three-way valve 31 (the first communication switching unit) and the second three-way valve 32 (the second communication switching unit) when the purge pump 24 and the purge valve 25 are operated (i.e., turned ON) under the predetermined condition to sequentially set the reference pressure measurement mode in which atmospheric air is pressure-fed to the intake passage 3 through the reference orifice 30, the purge pump 24, and the purge valve 25 and the leakage measurement mode in which the vapor collected in the canister 21 is pressure-fed to the intake passage 3 through the reference orifice 30, the purge pump 24, and the purge valve 25, and measure the reference pressure PB based on the passage pressure PP detected when the reference pressure measurement mode is set, measure the leakage pressure PL based on the passage pressure PP detected when the leakage measurement mode is set, and compare the measured reference pressure PB and the measured leakage pressure PL to determine whether or not leakage exists.

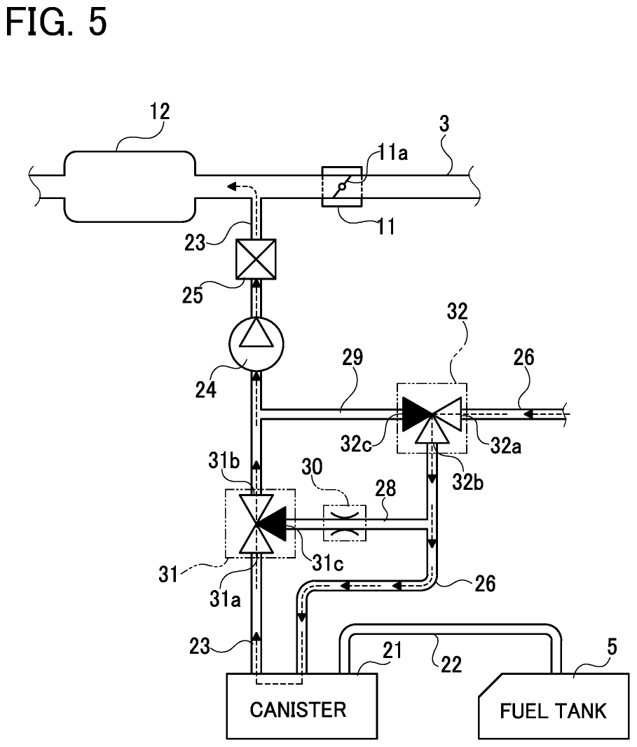

Herein, just for reference, FIG. 5 illustrates a schematic diagram showing the flow of vapor and others (indicated by dashed arrows) in the evaporated fuel treatment apparatus 20 in a purge control mode. As shown in FIG. 5, in the purge control mode, the first three-way valve 31 and the second three-way valve 32 are each turned OFF during operation of the purge pump 24 and the purge valve 25. At that time, the vapor flowing out of the canister 21 to the purge passage 23 passes the first three-way valve 31, the purge pump 24, and the purge valve 25 and further flows in the intake passage 3 through the outlet of the purge passage 23. At that time, the air sucked from the atmosphere into the atmosphere passage 26 is sucked in the canister 21 through the second three-way valve 32 and the atmosphere passage 26, causing the vapor to flow from the canister 21, thereby scavenging the inside thereof.

According to the leakage diagnostic device for the evaporated fuel treatment apparatus in the present embodiment described above, the purge pump 24 that is originally used to pressure-feed vapor to the intake passage 3 is utilized and, for the purge passage 23 located upstream of the purge pump 24 and the atmosphere passage 26, there are provided the first bypass passage 28, the second bypass passage 29, the reference orifice 30, the first three-way valve 31 (the first communication switching unit), the second three-way valve 32 (the second communication switching unit), and the pressure sensor 47, so that a leakage in the evaporated fuel treatment apparatus 20 is diagnosed by simple comparison between the reference pressure PB measured in the reference pressure measurement mode set and the leakage pressure PL measured in the leakage measurement mode. Accordingly, this configuration additionally needs no dedicated pump for leakage diagnosis. Furthermore, the purge pump 24 is provided in the purge passage 23. When a flow of vapor from the canister 21 to the purge pump 24 is shut off by the first three-way valve 31, the second bypass passage 29 is connected to a suction side of the purge pump 24 through the second three-way valve 32 provided on the side of the atmosphere passage 26 in which the vapor is less likely to flow, so that the inside of the canister 21 is set in a negative pressure. This configuration can dispense with a dedicated pump for leakage diagnosis, and perform effective leakage diagnosis while preventing an increase in the number of components and a complicated configuration of the leakage diagnostic device.

According to the present embodiment configured as above, for example, even when a vehicle is stopped in a high-altitude place and the leakage diagnosis is performed, a flow of air is caused to pass through an orifice corresponding to the opening area of the reference orifice 30 and the leakage pressure PL under the atmospheric pressure in such a high-altitude place is compared with the reference pressure PB in the high-altitude place, so that the leakage can be effectively determined. This can enhance the accuracy of leakage diagnosis.

According to the present embodiment configured as above, the predetermined condition for leakage diagnosis includes a state where the fuel temperature TF is equal to or lower than the predetermined value. Accordingly, the leakage diagnosis is performed in the state where the fuel temperature TF is equal to or lower than the predetermined value, that is, in a state that less vapor is released to the atmosphere passage 26. This configuration can prevent release of vapor to the atmosphere during the leakage diagnosis.

According to the present embodiment configured as above, the predetermined condition for leakage diagnosis includes a state where the vapor concentration DV is equal to or lower than the predetermined value. Accordingly, the leakage diagnosis is performed in the state where the vapor concentration DV is equal to or lower than the predetermined value, that is, in a state that less vapor is released to the atmosphere passage 26. This configuration can prevent release of vapor to the atmosphere during the leakage diagnosis.

According to the present embodiment configured as above, a part of the purge passage 23, a part of the atmosphere passage 26, the first bypass passage 28, the second bypass passage 29, the first three-way valve 31, and the second three-way valve 32 are integrally provided in a single housing. Thus, the leakage diagnostic device is constructed by for example providing such a single integrated housing to the canister 21. This leakage diagnostic device can save the installation space.

The foregoing embodiments are mere examples and give no limitation to the present disclosure. The present disclosure may be embodied in other specific forms without departing from the essential characteristics thereof.

(1) In the present embodiment, the first communication switching unit is constituted of the first three-way valve 31 and the second communication switching unit is constituted of the second three-way valve 32. As an alternative, each of these communication switching units may be constituted of a plurality of opening and closing valves in combination. For example, the first communication switching unit may be constituted of a first opening and closing valve provided in the purge passage downstream of the first junction and a second opening and closing valve provided in the first bypass passage upstream of the first junction. Further, the second communication switching unit may be constituted of a third opening and closing valve provided in the atmosphere passage upstream of the second junction and a fourth opening and closing valve provided in the second bypass passage downstream of the second junction.

(2) In the foregoing embodiment, there is provided the unit for estimating the fuel temperature TF of the inside of the fuel tank 5. As an alternative, a unit for detecting this fuel temperature TF, e.g., a fuel temperature sensor, may be provided.

(3) In the foregoing embodiment, there is provided the unit for estimating the vapor concentration DV of the vapor trapped in the canister 21. As an alternative, a unit for detecting this vapor concentration DV, e.g., a vapor concentration sensor, may be provided.

(4) In the foregoing embodiment, in the engine system equipped with no supercharger, the purge passage 23 is configured to communicate with the intake passage 3 downstream of the throttle valve 11a to purge vapor. In contrast, in an engine system equipped with a supercharger, a purge passage may be configured to communicate with the intake passage upstream of the throttle valve but downstream of the air flow meter to purge vapor.

### INDUSTRIAL APPLICABILITY

The present disclosure is applicable to an engine system configured to supply a fuel from a fuel tank to an engine.

### REFERENCE SIGNS LIST

1 Engine
3 Intake passage
5 Fuel tank
20 Evaporated fuel treatment apparatus
21 Canister
21a Atmosphere port
21b Inlet port
21c Outlet port
23 Purge passage
24 Purge pump
26 Atmosphere passage
28 First bypass passage
29 Second bypass passage
30 Reference orifice
31 First three-way valve (First communication switching unit)
32 Second three-way valve (First communication switching unit)
44 Water temperature sensor (Fuel temperature estimation unit)
46 A/F sensor (Evaporated fuel concentration estimation unit)
47 Pressure sensor (Pressure detection unit)
50 ECU (Control unit, Fuel temperature estimation unit, Evaporated fuel concentration estimation unit)

1. A leakage diagnostic device for diagnosing leakage in an evaporated fuel treatment apparatus for purging and treating evaporated fuel generated in a fuel tank to an intake passage of an engine, wherein
the evaporated fuel treatment apparatus comprises:
a canister configured to trap the evaporated fuel generated in the fuel tank,
the canister including an inlet port for introducing the evaporated fuel from the fuel tank into the canister, an outlet port for discharging the evaporated fuel from the canister, and an atmosphere port for introducing atmospheric air into the canister;
a purge passage configured to guide the evaporated fuel trapped in the canister to the intake passage through the outlet port;
a purge pump provided in the purge passage and configured to pressure-feed the evaporated fuel trapped in the canister to the intake passage through the purge passage; and
an atmosphere passage configured to introduce atmospheric air into the canister through the atmosphere port,
the leakage diagnostic device comprises:
a first bypass passage connecting between the purge passage upstream of the purge pump and the atmosphere passage;
a second bypass passage arranged in parallel with the first bypass passage between the purge passage upstream of the purge pump and the atmosphere passage, the second bypass passage having one end connected to the purge passage downstream of a first junction in which the first bypass passage and the purge passage are connected to each other and an other end connected to the atmosphere passage upstream of a junction in which the atmosphere passage and the first bypass passage are connected to each other;
a reference orifice provided in the first bypass passage and configured to create a pressure difference between the purge passage and the atmosphere passage;
a first communication switching unit configured to selectively switch between communication of the purge passage in the first junction and communication between the purge passage downstream of the first junction and the first bypass passage;
a second communication switching unit configured to selectively switch between communication between the atmosphere passage and the second bypass passage in a second junction in which the atmosphere passage and the second bypass passage are connected to each other and communication of the atmosphere passage in the second junction;
a pressure detecting unit configured to detect a passage pressure in the purge passage between the purge pump and the first junction; and
a control unit configured to control the purge pump, the first communication switching unit, and the second communication switching unit, and diagnose the leakage based on the passage pressure detected, and
the control unit is configured to:
control the first communication switching unit and the second communication switching unit under a predetermined condition during operation of the purge pump to sequentially set a reference pressure measurement mode in which atmospheric air is pressure-fed into the intake passage through the reference orifice and the purge pump and a leakage measurement mode in which the evaporated fuel trapped in the canister is pressure-fed into the intake passage through the reference orifice and the purge pump;
measure a reference pressure based on the passage pressure detected when the reference pressure measurement mode is set;
measure a leakage pressure based on the passage pressure detected when the leakage measurement mode is set, and
compare between the measured reference pressure and the measured leakage pressure to determine whether or not the leakage exists.

2. The leakage diagnostic device for an evaporated fuel treatment apparatus according to claim 1, wherein the reference orifice has an opening area set to a predetermined reference value.

3. The leakage diagnostic device for an evaporated fuel treatment apparatus according to claim 1, further including a unit configured to detect or estimate a fuel temperature in the fuel tank,
wherein the predetermined condition includes a condition that the detected or estimated fuel temperature is equal to or lower than a predetermined value.

4. The leakage diagnostic device for an evaporated fuel treatment apparatus according to claim 1, further including a unit configured to detect or estimate a concentration of the evaporated fuel trapped in the canister,
wherein the predetermined condition includes a condition that the detected or estimated concentration of the evaporated fuel is equal to or lower than a predetermined value.

5. The leakage diagnostic device for an evaporated fuel treatment apparatus according to claim 2, further including a unit configured to detect or estimate a fuel temperature in the fuel tank,
wherein the predetermined condition includes a condition that the detected or estimated fuel temperature is equal to or lower than a predetermined value.

6. The leakage diagnostic device for an evaporated fuel treatment apparatus according to claim 2, further including a unit configured to detect or estimate a concentration of the evaporated fuel trapped in the canister,
wherein the predetermined condition includes a condition that the detected or estimated concentration of the evaporated fuel is equal to or lower than a predetermined value.

7. The leakage diagnostic device for an evaporated fuel treatment apparatus according to claim 3, further including a unit configured to detect or estimate a concentration of the evaporated fuel trapped in the canister,
wherein the predetermined condition includes a condition that the detected or estimated concentration of the evaporated fuel is equal to or lower than a predetermined value.

8. The leakage diagnostic device for an evaporated fuel treatment apparatus according to claim 5, further including a unit configured to detect or estimate a concentration of the evaporated fuel trapped in the canister,
wherein the predetermined condition includes a condition that the detected or estimated concentration of the evaporated fuel is equal to or lower than a predetermined value.
